(19) United States
(12) Patent Application Publication
(10) Pub. No.: US 2004/0254269 A1
(43) Pub. Date: Dec. 16, 2004

(54) Organosilicon compounds that can be used as a coupling agent

(76) Inventors: Pierre Barruel, Francheville (FR); Nathalie Guennouni, Irigny (FR); Gilbert Krisch, Norroy Le Veneur (FR); Gerard Mignani, Lyon (FR)

Correspondence Address: BURNS DOANE SWECKER & MATHIS L L P, POST OFFICE BOX 1404, ALEXANDRIA, VA, 22313-1404, US

(21) Appl. No.: 10/482,152

(22) PCT Filed: Jun. 27, 2002
(86) PCT No.: PCT/FR02/02229

(30) Foreign Application Priority Data
Jun. 28, 2001 (FR) 01 08528

(51) Int. Cl. C08L 1/00

(52) U.S. Cl. 524/86

(57) ABSTRACT

The invention relates to organosilicon compounds selected from, inter alia, functional polysilylated organosilicon compounds bearing polythiosulphenamide function groups having formula (I): R1—Sx—NR2—R3, wherein R1, x, R2 and R3 are as defined in claim 1. Said compounds can be used as white filler/elastomer coupling agents in diene rubber compositions comprising, by way of reinforcing filler, a white filler such as a siliceous material.

The invention relates to novel organosilicon compounds, to processes for preparing them and to their use as white filler-elastomer coupling agents in rubber compounds comprising a white filler, especially a siliceous material, as reinforcing filler. The invention is also directed toward rubber compounds containing such a coupling agent and articles based on one of these compounds.

The coupling agents of the invention are particularly useful in the preparation of elastomer articles that are subjected to a variety of stresses such as temperature variation, a large dynamic frequency stress variation, a large static stress or a large dynamic bending fatigue. Examples of articles of this type include conveyor belts, power transmission belts, flexible tubes, expansion seals, seals for household appliances, supports acting as engine vibration extractors either with metallic armoring or with a hydraulic fluid inside the elastomer, cables, cable sheaths, shoe soles and rollers for cable cars.

Elastomer compounds that are suitable for preparing such articles must have the following properties:

rheological properties marked by viscosities that are as low as possible for great ease of use of the raw blends prepared, in particular as regards extrusion and calendering operations;

vulcanization times that are as short as possible to achieve excellent production efficiency for the vulcanization plant;

excellent reinforcing properties imparted by a filler, in particular optimum values of tensile modulus of elasticity, tensile breaking strength and abrasion resistance.

To achieve such an objective, numerous solutions have been proposed, which are essentially focused on the use of elastomer(s) modified with a reinforcing filler. It is generally known that in order to obtain the optimum reinforcing properties imparted by a filler, this filler should be present in the elastomer matrix in a final form that is both as finely divided as possible and as uniformly distributed as possible. However, such conditions can be achieved only if the filler has a very good capacity firstly to be incorporated into the matrix during the blending with the elastomer(s) and to be disintegrated, and secondly to be uniformly dispersed in the elastomer matrix.

In a known manner, carbon black is a filler that has such capacities, but this is not generally the case for white fillers. The use of reinforcing white filler alone, especially reinforcing silica alone, has been found to be unsuitable on account of the poor level of certain properties of such compositions and consequently of certain properties of articles using these compositions. For reasons of mutual affinity, white filler particles, especially silica particles, have an annoying tendency to aggregate together in the elastomer matrix. These fillers/filler interactions have the harmful consequence of limiting the dispersion of the filler and thus of limiting the reinforcing properties to a level that is substantially inferior to that which would theoretically be achievable if all the bonds (white filler-elastomer) capable of being created during the blending operation were indeed obtained. What is more, these interactions also tend to increase the viscosity in the raw state of the elastomer compounds, and thus to make them more difficult to use than in the presence of carbon black.

It is known to those skilled in the art that it is necessary to use a coupling agent, also known as a bonding agent, whose function is to ensure the connection between the surface of the white filler particles and the elastomer, while at the same time facilitating the dispersion of this white filler in the elastomer matrix.

The term “(white filler-elastomer) coupling agent” means, in a known manner, an agent capable of establishing a sufficient connection, of chemical and/or physical nature, between the white filler and the elastomer; such a coupling agent, which is at least difunctional, has, for example, the simplified general formula “Y—B—X” in which:

Y represents a functional group (function Y) that is capable of bonding physically and/or chemically to the white filler, such a bond possibly being established, for example, between a silicon atom of the coupling agent and the surface hydroxyl (OH) groups of the white filler (for example the surface silanols when it is a silica);

X represents a functional group (function X) capable of bonding physically and/or chemically to the elastomer, for example via a sulfur atom;

B represents a divalent organic group for connecting Y and X.

Coupling agents should in particular not be confused with simple white filler coating agents, which, in a known manner, may comprise the function Y that is active with respect to the white filler, but which lack the function X that is active with respect to the elastomer.

Coupling agents, especially silica-elastomer coupling agents, have been described in a large number of documents, the ones most widely used being difunctional alkoxysilanes bearing a trialkoxy group as function Y, and, as function X, a group capable of reacting with the elastomer, for instance a sulfur-containing functional group.

Thus, it has been proposed in patent application FR-A-2 094 859 to use a mercaptoalkoxy-silane in order to increase the affinity of silica with the elastomer matrix. It has been demonstrated, and it is nowadays well known, that mercaptoalkoxysilanes, and in particular γ-mercaptopropyltrimethoxysilane, are capable of affording excellent silica-elastomer coupling properties, but that the industrial use of these coupling agents is not possible on account of the high reactivity of the —SH group (function X), which very quickly leads, during the preparation of the elastomer compound of rubber type in an internal mixer, to crosslinking reactions during the blending, also known as “scorching”, to high viscosities, and ultimately to compounds that are virtually impossible to process and to use industrially. In order to illustrate this impossibility of the industrial use of such coupling agents and the rubber compounds containing them, mention may be made of documents FR-A-2 206 330, U.S. Pat. Nos. 4,002,594 and 3,873,489.

To overcome this drawback, it has been proposed to replace these mercaptoalkoxysilanes with alkoxysilane polysulfides, especially bis-tri(C₁-C₄) alkoxysilylpropyl polysulfides as described in numerous patents or patent applications (see for example FR-A-2 149 339, FR-A-2 206 330, U.S. Pat. Nos. 3,842,111, 3,873,489 and 3,997,581). Among these polysulfides, mention will be made especially of bis(3-triethoxysilylpropyl)tetrasulfide (abbreviated as TESPT), which is generally considered at the present time as being the product that provides, for silica-filled vulcanizates, the best compromise in terms of scorch safety, ease of use and reinforcing power, but which has the known drawback of being very expensive and of needing to be used usually in relatively large amounts (see for example patents U.S. Pat. Nos. 5,652,310, 5,684,171 and 5,684,172).

Now, unexpectedly, the Applicant has discovered during its research that specific coupling agents may have coupling performance qualities superior to those of alkoxysilane polysulfides, especially to those of TESPT, in rubber compounds. These coupling agents are organosilicon compounds comprising, per molecule, linked to silicon atoms, on the one hand, at least one hydroxyl group or one hydrolyzable monovalent group (noted as function Y), and on the other hand, and this is one of the essential characteristics of the organosilicon compounds according to the present invention, at least one particular polythiosulfenamide functional group (noted function X). These coupling agents moreover do not pose the abovementioned problems of premature scorching and the implementation problems associated with an excessive viscosity of the rubber compounds in the raw state, which are drawbacks that arise especially in the case of mercaptoalkoxysilanes.

### FIRST SUBJECT OF THE INVENTION

Consequently, a first subject of the invention relates to a novel organosilicon compound comprising, per molecule, linked to silicon atoms, on the one hand, at least one hydroxyl group or a hydrolyzable monovalent group, and, on the other hand, a function X capable of reacting with a rubber elastomer, said organosilicon compound being characterized in that the function X consists of at least one polythiosulfenamide functional group of formula:

—R¹—Sₓ—NR²R³ (I)

in which:

the free valency is linked to a silicon atom of the organosilicon compound;

the symbol R¹ represents a divalent radical chosen from: a saturated or unsaturated aliphatic hydrocarbon-based group; a saturated, unsaturated and/or aromatic, monocyclic or polycyclic carbocyclic group; and a group containing a saturated or unsaturated aliphatic hydrocarbon-based portion and a carbocyclic portion as defined above; said divalent radical being optionally substituted or interrupted with an oxygen atom and/or a nitrogen atom bearing 1 or 2 monovalent groups chosen from: a hydrogen atom; a saturated or unsaturated aliphatic hydrocarbon-based group; a saturated, unsaturated and/or aromatic, monocyclic or polycyclic carbocyclic group; and a group containing a saturated or unsaturated aliphatic hydrocarbon-based portion and a carbocyclic portion as defined above;

x is an integer or fractional number ranging from 2 to 4;

one of the substituents of the nitrogen atom, R² or R³, represents: a hydrogen atom; a saturated aliphatic hydrocarbon-based group; a saturated and/or aromatic, monocyclic or polycyclic carbocyclic group; a group containing a saturated aliphatic hydrocarbon-based portion and a saturated and/or aromatic, monocyclic or polycylic carbocyclic portion; or the group of formula:

—Sₐ—R⁴—Si≡ (II)

in which:

a represents a number equal to 0 or x; when a=x, the symbols x of formulae (I) and (II) may then be identical or different;

the symbol R⁴ takes any of the meanings given above for R¹, the symbols R¹ and R⁴ possibly being identical or different;

the symbol Si≡ represents a silicon atom of the organosilicon compound other than the atom to which the free valency of the radical R¹ of formula (I) is linked;

the other substituent of the nitrogen atom, R³ or R², respectively, represents the group of formula (II) as defined above, with the condition according to which the symbol Si≡ then represents a silicon atom of the organosilicon compound, which, on the one hand, is other than the silicon atom to which the free valency of the radical R¹ of formula (I) is linked, and, on the other hand, is again other than the silicon atom of the other group of formula (II), in the case where the two substituents of the nitrogen atom, R² and R³, each represent a group of formula (II).

In the present description, it will be pointed out that the symbol x of formula (I) is an integer or fractional number, which represents the number of sulfur atoms present in a molecule of the group of formula (I). This number may be an exact number of sulfur atoms when the route for synthesizing the group under consideration gives rise to only one kind of polysulfide group. However, this number may be the average of the number of sulfur atoms per molecule of the group under consideration, if the synthetic route chosen gives rise to a mixture of polysulfide groups each having a different number of sulfur atoms; in this case, the polythiosulfenamide group synthesized consists; in fact, of a distribution of polysulfides, ranging from the disulfide S₂ to heavier polysulfides, centered around an average molar value (value of the symbol x) which is in the general range indicated (x ranging from 2 to 4).

In the text hereinabove, the expression “aliphatic hydrocarbon-based group” means an optionally substituted linear or branched group preferably containing from 1 to 25 carbon atoms.

Advantageously, said aliphatic hydrocarbon-based group contains from 1 to 12 carbon atoms, better still from 1 to 8 carbon atoms and even better still from 1 to 4 carbon atoms.

Saturated aliphatic hydrocarbon-based groups that may be mentioned include alkyl groups such as methyl, ethyl, propyl, isopropyl, butyl, isobutyl, t-butyl, pentyl, isopentyl, neopentyl, 2-methylbutyl, 1-ethylpropyl, hexyl, isohexyl, neohexyl, 1-methylpentyl, 3-methylpentyl, 1,1-dimethylbutyl, 1,3-dimethylbutyl, 2-ethylbutyl, 1-methyl-1-ethylpropyl, heptyl, 1-methyl-hexyl, 1-propylbutyl, 4,4-dimethylpentyl, octyl, 1-methylheptyl, 2-ethylhexyl, 5,5-dimethylhexyl, nonyl, decyl, 1-methylnonyl, 3,7-dimethyloctyl and 7,7-di-methyloctyl radicals.

The unsaturated aliphatic hydrocarbon-based groups comprise one or more unsaturations, preferably one, two or three unsaturations of ethylenic type (double bond) and/or acetylenic type (triple bond).

Examples of these are alkenyl or alkynyl groups derived from the alkyl groups defined above by removal of two or more hydrogen atoms. Preferably, the unsaturated aliphatic hydrocarbon-based groups comprise only one unsaturation.

In the context of the invention, the term “carbocyclic group” means an optionally substituted, preferably C₃-C₅₀ monocyclic or, polycyclic radical. Advantageously, it is a C₃-C₁₈ radical, which is preferably monocyclic, bicyclic or tricyclic. When the carbocyclic group comprises more than one ring nucleus (in the case of the polycyclic carbocycles), the ring nuclei are fused in pairs. Two fused nuclei may be ortho-fused or peri-fused.

The carbocyclic group may comprise, unless otherwise indicated, a saturated portion and/or an aromatic portion and/or an unsaturated portion.

Examples of saturated carbocyclic groups are cycloalkyl groups. Preferably, the cycloalkyl groups are C₃-C₁₈ and better still C₅-C₁₀. Mention may be made especially of cyclopentyl, cyclohexyl, cycloheptyl, cyclooctyl, adamantyl or norbornyl radicals.

The unsaturated carbocycle or any unsaturated portion of carbocyclic type contains one or more ethylenic unsaturations, preferably one, two or three. It advantageously contains from 6 to 50 and better still from 6 to 20 carbon atoms, for example from 6 to 18 carbon atoms. Examples of unsaturated carbocycles are C₆-C₁₀ cycloalkenyl groups.

Examples of aromatic carbocyclic radicals are (C₆-C₈)aryl groups and especially phenyl, naphthyl, anthryl and phenanthryl groups.

A group containing both a hydrocarbon-based aliphatic portion as defined above and a carbocyclic portion as defined above is, for example, an arylalkyl group such as benzyl, or an alkylaryl group such as tolyl.

The substituents of the hydrocarbon-based aliphatic groups or portions and of the carbocyclic groups or portions are, for example, alkoxy groups in which the alkyl portion is preferably as defined above.

The expression “hydrolyzable monovalent group” mentioned above with respect to the function Y means a group which, by hydrolysis, allows attachment to a silicon atom and which it is possible to displace especially by the action of water.

Such groups are, for example: halogen atoms, especially chlorine; groups —O—G¹ and —O—CO—G¹ in which G¹ represents: a saturated or unsaturated aliphatic hydrocarbon-based group, or a saturated, unsaturated and/or aromatic, monocyclic or polycyclic carbocyclic group, or a group containing a saturated or unsaturated aliphatic hydrocarbon-based portion and a carbocyclic portion as defined above, G¹ possibly being halogenated and/or substituted with one or more alkoxy groups; the groups —O—N═CG⁵G⁶ in which G⁵ and G⁶, independently take any of the meanings given above for G¹, G⁵ and G⁶ possibly being halogenated and/or optionally substituted with one or more alkoxy groups; the groups —O—NG⁵G⁶ in which G⁵ and G⁶ are as defined above.

Advantageously, such a hydrolyzable monovalent group is a radical chosen from the following: linear or branched C₁-C₈ alkoxy optionally halogenated and/or optionally substituted with one or more (C₁-C₈)alkoxy; C₂-C₉ acyloxy optionally halogenated or optionally substituted with one or more (C₁-C₈)alkoxy; C₅-C₁₀cycloalkoxy; or C₆-C₁₈ aryloxy. By way of example, the hydrolyzable group is methoxy, ethoxy, n-propoxy, isopropoxy, n-butoxy, methoxymethoxy, ethoxyethoxy, methoxyethoxy, β-chloropropoxy or β-chloroethoxy, or alternatively acetoxy.

According to a first particularly suitable embodiment of the invention, the polythiosulfenamide group corresponds to formula (I) in which at least one of the substituents of the nitrogen atom, R² and R³, has the formula (II) with a=0, i.e. when it is R³ that has said formula (II) with a=0, it corresponds to the formula:

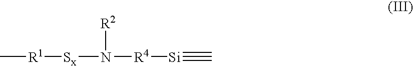

in which:

R¹ represents: an alkylene chain (for example a C₁-C₈ alkylene chain); a saturated cycloalkylene group (for example a C₅-C₁₀ cycloalkylene group); an arylene group (for example a C₆-C₁₈ arylene group); or a divalent group consisting of a combination of at least two of these radicals. One meaning of R′ which is particularly suitable is (C₁-C₈) alkylene, in particular (C₁-C₄) alkylene, for example methylene, ethylene and better still propylene;

x is an integer or fractional number ranging from 2 to 3. One meaning of x which is particularly suitable is x=2;

R² represents: a hydrogen atom; a linear or branched C₁-C₈ alkyl radical; a C₅-C₁₀ cycloalkyl radical; a C₆-C₁₈ aryl radical; a (C₆-C₁₈)aryl(C₁-C₈)alkyl radical; or the group of formula (II) in which a=0 and the symbol R⁴ has the broad definitions mentioned below. In a particularly suitable manner, the symbol R² is chosen from the group formed by hydrogen, methyl, ethyl, propyl, isopropyl, butyl, hexyl, cyclohexyl, phenyl and benzyl radicals and organosilyl radicals of formula (II) in which a=0 and R⁴ has the specific definitions mentioned below;

the symbol R⁴ takes any of the broad or specific meanings given just above for R¹, the symbols R¹ and R⁴ possibly being identical or different.

According to a second particularly suitable embodiment of the invention, the polythiosulfenamide group corresponds to formula (I) in which only one of the substituents of the nitrogen atom, R² or R³, has the formula (II) with a=x, i.e. it corresponds, when it is R³ that has, for example, said formula (II) with a=x, to the formula:

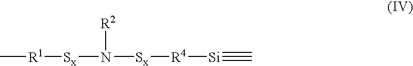

in which the symbols R¹, x, R² and R⁴ take any of the broad or specific meanings given above in “the first particularly suitable embodiment of the invention”, with the additional condition according to which the symbols x of the formula given above may be identical or different.

Without this other embodiment of the invention being limiting, a preferred group of organosilicon compounds according to the invention consists of polysilyl organosilicon compounds comprising, per molecule, on the one hand, at least two silyl units, at least one of which bears one, two or three group(s) chosen from a hydroxyl group and/or a hydrolyzable monovalent group linked to the silicon atom (function Y), and on the other hand, a polythio-sulfenamide functional group of formula (I) (function X) which is linked to the silicon atom of the function Y via the free valency of R¹.

In this preferred group, the functional polysilyl organosilicon compounds that are suitable for use correspond to the general formula:

(G²)_{b}(G¹)_{3-b}Si—R¹—Sx—NR²R³ (V)

in which:

b represents a number chosen from 1, 2 and 3;

the symbols G¹, which may be identical or different, each represent: a saturated or unsaturated aliphatic hydrocarbon-based group; a saturated, unsaturated and/or aromatic, monocyclic or polycyclic carbocyclic group; or a group containing a saturated or unsaturated aliphatic hydrocarbon-based portion and a carbocyclic portion as defined above;

the symbols G², which may be identical or different, each represent: a hydroxyl group or a hydrolyzable monovalent group;

R¹, x, R² and R³ take any of the general meanings given above with respect to the formula (I), with the additional condition according to which one of the substituents R² or R³ or both the substituents R² and R³ then represent(s) a silyl group of formula:

—Sₐ—R⁴—Si(G⁴)_{3-b′}(G³)_{b′} (II′)

in which:

a and R⁴ have the general meanings given above with respect to formula (II);

G³, G⁴ and b′ have, respectively, the same meanings as G², G¹ and b given just above in formula (V), the symbols G³, G⁴ and b′ possibly being, respectively, identical to or different than the symbols G², G¹ and b.

A first subgroup of preferred organosilicon compounds that are most particularly suitable for use consist of functional polysilyl organosilicon compounds in which, in the polythiosulferiamide group, at least one of the substituents R² and R³ corresponds to the particular formula (II′) with a=0; such compounds, in the case where only one substituent R³ for example corresponds to the particular formula (II′) with a=0, have the formula:

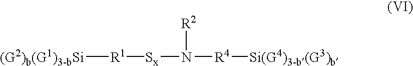

in which:

R¹, x, R² and R⁴ take any of the broad or specific meanings given above in the “first particularly suitable embodiment of the invention” for formula (III);

b represents a number chosen from 1, 2 and 3;

the symbols G¹, which may be identical or different, each represent: a linear or branched C₁-C₈ alkyl radical; a C₅-C₁₀cycloalkyl radical or a C₆-C₁₈ aryl radical. More specifically, the symbols G¹ are chosen from the group formed by methyl, ethyl, propyl, isopropyl, cyclohexyl and phenyl radicals;

the symbols G², which may be identical or different, each represent: a linear or branched C₁-C₈ alkoxy radical, optionally substituted with one or more (C₁-C₈)alkoxy groups. More specifically, the symbols G² are chosen from the group formed by methoxy, ethoxy, n-propoxy, isopropoxy, methoxymethoxy, ethoxyethoxy and methoxyethoxy radicals;

G³, G⁴ and b′ have, respectively, the same broad or specific definitions as G², G¹ and b given just above, the symbols G³, G⁴ and b′ possibly being, respectively, identical to or different than the symbols G², G¹ and b.

As organosilicon compounds of this first subgroup, examples that will be mentioned include:

N-(3′-trimethoxysilylpropyldithio)-3-triethoxysilyl propylamine;

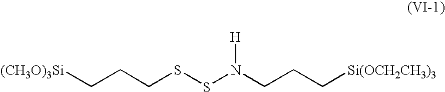

N-(3′-triethoxysilylpropyldithio)-3-triethoxysilyl propylamine;

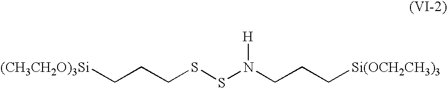

N-methyl-N-(3′-triethoxysilylpropyldithio)-3′-trimethoxysilyl propylamine

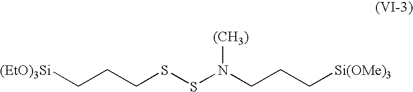

A second subgroup of preferred organosilicon compounds that are most particularly suitable for use consists of functional polysilyl organosilicon compounds in which, in the polythiosulfenamide group, only one of the substituents R² or R³ corresponds to the particular formula (II′) with a=x; such compounds, in the case where it is the substituent R³ that, for example, alone corresponds to the particular formula (II′) with a=x, have the formula:

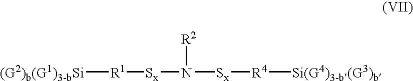

in which R¹, x, R², R⁴, b, G¹, G², G³, G⁴ and b′ have, respectively, the same broad or specific meanings as those given above in formula (VI), the symbols x possibly being identical or different and the symbols R⁴, G³, G⁴ and b′ possibly being, respectively, identical to or different than the symbols R¹, G², G¹ and b.

As organosilicon compounds of this second subgroup, examples that will be mentioned include:

N,N-bis(3-trimethoxysilylpropyldithio)cyclohexylamine.

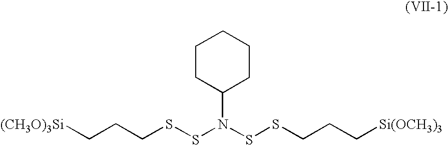

N,N-bis(3-triethoxysilylpropyldithio)cyclohexylamine.

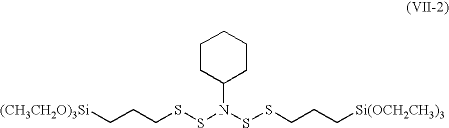

N,N-bis(3-trimethoxysilylpropyldithio)-3-triethoxysilylpropylamine.

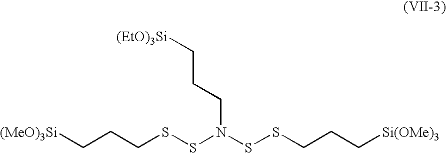

### SECOND SUBJECT OF THE INVENTION

The organosilicon compounds of the invention may be prepared, and this constitutes the second subject of the present invention, by performing one of the following methods or related methods.

Method A

The polysilyl compounds of formula (V), (VI) or (VII) in which x=2 may be obtained by reacting a disulfide halide of formula:

(G²)_{b}(G¹)_{3-b}Si—R¹—S—S-Hal (VIII)

in which G², G¹, b and R¹ are as defined above and Hal represents a halogen atom, preferably a chlorine atom, with the appropriate amine of formula:

HNR²R³ (IX)

in which R² and R³ are as defined above, in the presence of a base, preferably an organic base.

In the context of the invention, the term “halogen” represents bromine, chlorine, fluorine or iodine.

Examples of suitable bases include N-methyl-morpholine, triethylamine, tributylamine, diisopropylethylamine, dicyclohexylamine, N-methyl-piperidine, pyridine, 4-(1-pyrrolidinyl)pyridine, picoline, 4-(N,N-dimethylamino)pyridine, 2,6-di-t-butyl-4-methylpyridine, quinoline, N,N-dimethylaniline, N,N-diethylaniline, 1,8-diazabicyclo[5.4.0]undec-7-ene (DBU), 1,5-diazabicyclo[4.3.0]non-5-ene (DBN) and 1,4-diazabicyclo[2.2.2]octane (DABCO or triethylenediamine).

The reaction is preferably performed in a polar aprotic solvent such as an ether, for example diethyl ether, diisopropyl ether, tetrahydrofuran, dioxane, dimethoxyethane or diethylene glycol dimethyl ether. Diethyl ether is preferred.

The reaction temperature depends on the reactivity of the molecules present and on the strength of the base used. This temperature generally ranges between −78° C. and room temperature (+15 to +25° C.).

Advantageously, a temperature of between −78° C. and −50° C. is suitable.

Next, it is desirable to allow the medium to return to room temperature.

When the amine (IX) is a secondary amine (R² or R³ is other than H), the reaction is stoichiometric. In this case, the molar ratio of the amine (IX) to the disulfide halide (VIII) is between 1 and 2 and better still between 1 and 1.5.

When the amine (IX) is primary (R² or R³ is H), then the amount used depends on the nature of the targeted reaction product. In order to obtain a compound of formula (V), (VI) or (VII) in which R² or R³ represents H, the amine (IX) will be in excess in the reaction medium. The molar ratio (IX)/(VIII) generally ranges between 1 and 3, this ratio generally being closer to 1, for example chosen between 1 and 1.2. In order to obtain a compound of formula (VII) in which R² or R³ represents the group:

—S—S—R⁴—Si(G⁴)_{3-b′}(G³)_{b′}

in which R⁴, G⁴, b′ and G³ are, respectively, identical to R¹, G², b and G¹, the molar ratio of compound (VIII) to the amine (IX) will be greater than or equal to 2. This molar ratio (VIII)/(IX) will advantageously be between 2 and 2.3. The amount of base to be used for this reaction will be readily determined by a person skilled in the art, the base having the role of trapping the released halohydric acid. The molar ratio of the base to the compound of formula (VIII) is advantageously greater than or equal to 1, for example between 1 and 3.

Method B

The polysilyl compounds of formula (V), (VI) or (VII) in which x=2 may moreover be obtained by reacting a disulfide of formula:

(G²)_{b}(G¹)_{3-b}Si—R¹—S—S—J (X)

in which G², G¹, b and R¹ are as defined above and J represents an optionally substituted succinimido or phthalimido group, with the amine (IX) defined above, in the presence of a base, preferably an organic base.

The substitutents of the phthalimido and succinimido groups are organic substituents that are compatible with the reaction used, i.e. which are unreactive under the operating conditions used.

The bases that may be used are those defined above for method A.

Advantageously, the reaction is performed in a polar aprotic solvent, preferably in an aliphatic halogenated hydrocarbon (such as methylene chloride or carbon tetrachoride) or an optionally halogenated aromatic hydrocarbon (such as an optionally halogenated benzene or toluene).

The solvent is preferably CCl₄.

The reaction temperature is preferably between −10° C. and +100° C. and preferably between +10° C. and +50° C. The respective amounts of compounds (IX) and (X) placed in contact depend on the type of compound (V), (VI) or (VII) targeted, just as in the proceeding case (method A).

Reference will thus be made to method A for the determination of the molar amounts of (IX), (X) and of base to be reacted.

Method C

The compounds of formula (V), (VI) or (VII) in which x=2 may moreover be obtained by reacting an amino sulfide of formula:

J—S—NR²R³ (XI)

in which R², R³ and J are as defined above, with a thiol of formula:

(G²)_{b}(G¹)_{3-b}Si—R¹—SH (XII)

in which G², G¹, b and R¹ are as defined above, in the presence of a base, the base preferably being as defined above.

For this reaction, the reaction temperature advantageously ranges between +10 and +40° C. and more preferably between +15 and +30° C., for example between +18 and +25° C.

The reaction of compound (XII) with compound (XI) is generally performed in a polar aprotic solvent as defined in the case of method B.

Preferably, the solvent is benzene or toluene.

The reaction of compound (XI) with compound (XII) is a stoichiometric reaction. It is preferred to work in the presence of a slight excess of compound (XI). Thus, the molar ratio of (XI) to (XII) will generally be between 1 and 1.5 and better still between 1 and 1.3.

This variant may be performed, for example, for the preparation of compounds of formula (V), (VI) or (VII) in which R² or R³ is other than a hydrogen atom.

The compounds of formula (VIII) may be prepared by reacting sulfur dichloride (SCl₂) with a suitable mercaptosilane of formula (XII) as defined above, in the presence of an organic base, and preferably in the presence of triethylamine. This reaction is performed, for example, in an ether at a temperature of from −78 to −50° C. The organic bases and ethers are generally as defined above.

The amines (IX) are commercial or are readily prepared from commercial products.

The compounds of formula (X) are readily prepared by reacting a thiol of formula (XII) as defined above with the halide of formula:

J—S-Hal (XIII)

in which J and Hal are as defined above.

This reaction is preferably performed in the presence of a base, especially an organic base, at a temperature of from +10 to +50° C., for example from +15 to +30° C. and especially between +18 and +25° C., in a polar aprotic solvent generally as defined in method B. Preferably, the solvent is carbon tetrachloride, the base is triethylamine and the temperature is room temperature.

This reaction is stoichiometric. However, it is desirable to work in the presence of a deficit of thio (XII). Thus, the molar ratio of the compound J—S-Hal to compound (XII) is advantageously between 1 and 1.5 and better still between 1 and 1.3.

The compounds of formula (XI) are readily obtained by reacting an amine of formula (IX) with the halide of formula:

J—S-Hal (XIII)

in which J and Hal are as defined above, in the presence of an organic base. This reaction is preferably performed in a solvent such as a halogenated hydrocarbon (and especially carbon tetrachloride) at a temperature generally of between +10 and +50° C. and preferably between +15 and +30° C., for example between +18 and +25° C. (room temperature). Organic bases that will be selected are any of the bases defined above, for example triethylamine. As a variant, it is possible to use the reagent (IX) as base. In this case, at least two equivalents of amine (IX) will be used per one equivalent of the halide (XIII).

The compounds of formula (XII) are commercial or readily prepared from commercial compounds.

Scheme 1 below illustrates one route for synthesizing compound (XIII):

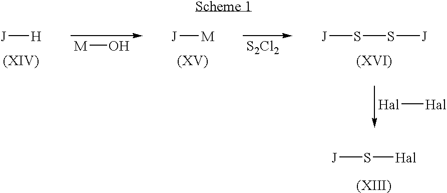

In this scheme, J and Hal are as defined above and M represents an alkali metal, preferably Na or K.

The commercial compound (XIV) is converted into an alkali metal salt via the action of a suitable mineral base, M—OH in which M is an alkali metal, such as an alkali metal hydroxide, in a C₁-C₄ lower alcohol such as methanol or ethanol. This reaction generally takes place at a temperature of from +15 to +25° C. The resulting salt of formula (XV) is reacted with S₂Cl₂ to give compound (XVI). The reaction conditions that are advantageous for this reaction are a polar aprotic solvent such as a halogenated aliphatic hydrocarbon (CH₂Cl₂ or CCl₄) and a temperature of between −20° C. and +10° C. Next, the action of Hal-Hal on compound (XVI) leads to the expected compound (XIII). In this last step, the process is preferably performed in a polar aprotic solvent such as a halogenated aliphatic hydrocarbon (such as chloroform or dichloromethane) at a temperature of between +15° C. and the reflux point of the solvent, preferably between +40° C. and +80° C., for example between +50 and +70° C.

According to one preferred embodiment, Hal represents chlorine, in which case Hal-Hal is introduced in gaseous form into the reaction medium.

Method D

The polysilyl compounds of formula (V), (VI) or (VII) in which x=3 may be obtained by performing the following sequence of steps:

(1) reaction of the thiol of formula (XII) with S₂(Hal)₂ in which Hal represents a halogen atom and, preferably, a chlorine atom, in the presence of a base, preferably an organic base, to give:

(G²)_{b}(G¹)_{3-b}Si—R¹—S—S—S-Hal (XVII)

This reaction is, for example, performed in an ether at a temperature of from −78 to −50° C. The organic bases and ethers are generally as defined above in method A; and

(2) reaction of compound (XVII) with the appropriate amine of formula (IX) in the presence of a base, preferably an organic base; for further details, reference may be made to the procedure described above with respect to the implementation of method A.

Method E

The polysilyl compounds of formula (V), (VI) or (VII) in which x=4 may be obtained by performing the following sequence of steps:

(1) reaction of the disulfide halide of formula (VIII) or of the trisulfide halide of formula (XVII) with the required amount of elementary sulfur [provision of 2 sulfur atoms in the case of compound (VIII) or provision of one sulfur atom in the case of compound (XVII)], working at a temperature ranging from +70° C. to +170° C., optionally in the presence of an aromatic solvent, to give the compound of formula:

(G²)_{b}(G¹)_{3-b}Si—R¹—S—S—S—S-Hal (XVIII)

(2) reaction of the compound of formula (XVIII) with the appropriate amine of formula (IX) in the presence of a base, preferably an organic base; for further details, reference may be made to the procedure described above with respect to the implementation of method A.

Third Subject of the Invention

According to another of its subjects, the present invention relates to the use of an effective amount of at least one organosilicon compound bearing group(s) of formula (I) containing a polythiosulfenamide function, as a white filler-elastomer coupling agent in compounds comprising at least one diene elastomer and a white filler as reinforcing filler, said compounds being intended for manufacturing articles made of diene elastomer(s).

As coupling agents that are particularly suitable for the intended use, mention will be made of organosilicon compounds each bearing group(s) of formula (III) having the definition given above in the context of the “first particularly suitable embodiment of the inventions”.

As other coupling agents that are particularly suitable for the intended use, mention will also be made of organosilicon compounds each bearing group(s) of formula (IV) having the definition given above in the context of the “second particularly suitable embodiment of the invention”.

The coupling agents that are preferably used and that are suitable for use consist of the functional polysilyl organosilicon compounds corresponding to formula (V) defined above.

As coupling agents of this type that are most particularly suitable for use, mention will be made of the functional polysilyl organosilicon compounds corresponding to formula (VI) having the definition given above in the context of the “first subgroup of preferred organosilicon compounds”.

As other coupling agents of this type that are most particularly suitable for use, mention will also be made of the functional polysilyl organosilicon compounds corresponding to formula (VII) having the definition given above in the context of the “second subgroup of preferred organosilicon compounds”.

Fourth Subject of the Invention

In the context of this coupling agent application, the present invention also relates, in a fourth subject, to diene elastomer compounds comprising a white reinforcing filler, obtained by using an effective amount (i) of at least one organosilicon compound bearing group(s) containing a polythiosulfenamide function of formula (I), (III) or (IV), or (2i), in particular, of at least one functional polysilyl organosilicon compound corresponding to the formula (V), (VI) or (VII).

More specifically, these compounds comprise (the parts are given on a weight basis):

per 100 parts of diene elastomer(s),

10 to 200 parts, preferably 20 to 150 and even more preferably 30 to 100 parts of white reinforcing filler,

1 to 20 parts, preferably 2 to 20 parts and even more preferably 2 to 12 parts of coupling agent(s).

Advantageously, the amount of coupling agent(s) chosen from the abovementioned general and preferential zones, is determined such that it represents from 0.5% to 20%, preferably from 1% to 15% and more preferably from 1% to 10% relative to the weight of the white reinforcing filler.

A person skilled in the art will understand that the coupling agent may be pregrafted onto the white reinforcing filler (via its function Y), the white filler thus “precoupled” then possibly being linked to the diene elastomer via the free function X.

In the present description, the expression “white reinforcing filler” is intended to define a “white” (i.e. inorganic or mineral) filler, occasionally known as a “clear” filler, capable by itself, without any means other than that of a coupling agent, of reinforcing an elastomer compound of natural or synthetic rubber type.

The physical state in which the white reinforcing filler is present is not critical, i.e. said filler may be in the form of powder, micropearls, granules or beads.

Preferably, the white reinforcing filler consists of silica, alumina or a mixture of these two species.

More preferably, the white reinforcing filler consists of silica, taken alone or as a mixture with alumina.

Any precipitated or pyrogenic silica known to those skilled in the art, with a BET specific surface area ≦450 m²/g, is suitable as a silica which may be used in the invention. Precipitation silicas are preferred, these possibly being conventional or highly dispersible.

The expression “highly dispersible silica” means any silica which has a very strong ability to de-aggregate and to disperse in a polymer matrix, which may be observed by electron or optical microscopy, on thin slices. Non-limiting examples of highly dispersible silicas which may be mentioned include those with a CTAB specific surface area of less than or equal to 450 m²/g, preferably ranging from 30 to 400 m²/g, and particularly those disclosed in patent U.S. Pat. No. 5,403,570 and patent applications WO-A-95/09127 and WO-A-95/09128, the content of which is incorporated herein. As nonlimiting examples of such preferred highly dispersible silicas, mention may be made of the silica Perkasil KS 430 from the company Akzo, the silica BV3380 from the company Degussa, the silicas Zeosil 1165 MP and 1115 MP from the company Rhodia, the silica Hi-Sil 2000 from the company PPG, and the silicas Zeopol 8741 or 8745 from the company Huber. Treated precipitated silicas such as, for example, the aluminum-“doped” silicas disclosed in patent application EP-A-0 735 088, the content of which is also incorporated herein, are also suitable.

More preferably, precipitation silicas that are particularly suitable are those with:

a CTAB specific surface area ranging from 100 to 240 m²/g and preferably from 100 to 180 m²/g,

a BET specific surface area ranging from 100 to 250 m²/g and preferably from 100 to 190 m²/g,

a DOP oil uptake of less than 300 ml/100 g and preferably ranging from 200 to 295 ml/100 g,

a BET specific surface/CTAB specific surface area ratio ranging from 1.0 to 1.6.

Needless to say, the term “silica” also means blends of different silicas. The CTAB specific surface area is determined according to NFT method 45007 of November 1987. The BET specific surface area is determined according to the Brunauer-Emmett-Teller method described in “The Journal of the American Chemical Society, vol. 60, page 309 (1938)” corresponding to NFT standard 45007 of November 1987. The DOP oil uptake is determined according to NFT standard 30-022 (March 1953) using dioctyl phthalate.

The alumina advantageously used as reinforcing alumina is a highly dispersible alumina with:

a BET specific surface area ranging from 30 to 400 m²/g and preferably from 60 to 250 m²/g,

an average particle size of not more than 500 nm and preferably not more than 200 nm, and

a high content of reactive Al—OH surface functions, as disclosed in document EP-A-0 810 258.

Non-limiting examples of such reinforcing aluminas which will be mentioned in particular include the aluminas A125, CR125 and D65CR from the company Baikowski.

The expression “diene elastomers that may be used for the compounds in accordance with the fourth subject of the invention” means, more specifically:

(1) the homopolymers obtained by polymerization of a conjugated diene monomer containing from 4 to 22 carbon atoms, for instance: 1,3-butadiene, 2-methyl-1,3-butadiene, 2,3-dimethyl-1,3-butadiene, 2,3-diethyl-1,3-butadiene, 2-methyl-3-ethyl-1,3-butadiene, 2-chloro-1,3-butadiene, 2-methyl-3-isopropyl-1,3-butadiene, 1-phenyl-1,3-butadiene, 1,3-pentadiene-2,4-hexadiene;

(2) the copolymers obtained by copolymerization of at least two of the abovementioned conjugated dienes with each other or by copolymerization of one or more of the abovementioned conjugated dienes with one or more ethylenically unsaturated monomers chosen from:

vinylaromatic monomers containing from 8 to 20 carbon atoms, for instance: styrene, ortho-, meta- or para-methylstyrene, the commercial “vinyl-toluene” mixture, para-tert-butylstyrene, methoxystyrenes, chlorostyrenes, vinylmesitylene, divinylbenzene, vinylnaphthalene;

vinyl nitrile monomers containing from 3 to 12 carbon atoms, for instance acrylonitrile or meth-acrylonitrile;

acrylic ester monomers derived from acrylic acid or from methacrylic acid with alkanols containing from 1 to 12 carbon atoms, for instance methyl acrylate, ethyl acrylate, propyl acrylate, n-butyl acrylate, isobutyl acrylate, 2-ethylhexyl acrylate, methyl methacrylate, ethyl methacrylate, n-butyl methacrylate or isobutyl methacrylate;

the copolymers may contain between 99% and 20% by weight of diene units and between 1% and 80% by weight of vinylaromatic, vinyl nitrile and/or acrylic ester units;

(3) the ternary copolymers obtained by copolymerization of ethylene or of an α-olefin containing 3 to 6 carbon atoms with a nonconjugated diene monomer containing from 6 to 12 carbon atoms, for instance the elastomers obtained from ethylene or from propylene with a nonconjugated diene monomer of the abovementioned type, such as, especially, 1,4-hexadiene, ethylidenenorbornene or dicyclopentadiene (EPDM elastomer);

(4) natural rubber;

(5) the copolymers obtained by copolymerization of isobutene and of isoprene (butyl rubber), and also the halogenated, in particular chlorinated or brominated, versions of these copolymers;

(6) a blend of several of the abovementioned elastomers (1) to (5) with each other.

Preferably, use is made of one or more elastomer(s) chosen from: (1) polybutadiene, polychloroprene, polyisoprene [or poly(2-methyl-1,3-butadiene)]; (2) poly(isoprene-butadiene), poly(isoprene-styrene), poly(isoprene-butadiene-styrene), poly(butadiene-styrene), poly(butadiene-acrylonitrile); (4) natural rubber; (5) butyl rubber; (6) a blend of elastomers, especially the abovementioned elastomers (1), (2), (4) and (5) with each other; (6′) a blend containing a majority amount (ranging from 51% to 99.5% and preferably from 70% to 99% by weight) of polyisoprene (1) and/or of natural rubber (4) and a minority amount (ranging from 49% to 0.5% and preferably from 30% to 1% by weight) of polybutadiene, polychloroprene, poly(butadiene-styrene) and/or poly(butadiene-acrylonitrile).

The compounds in accordance with the invention also contain all or some of the other additional constituents and additives usually used in the field of elastomer compounds and rubber compounds.

Thus, all or some of the other constituents and additives below may be used:

as regards the vulcanization system, mention will be made, for example, of:

vulcanizing agents chosen from sulfur and sulfur-donating compounds such as, for example, thiuram derivatives;

vulcanization accelerators such as, for example, guanidine derivatives or thiazole derivatives;

vulcanization activators such as, for example, zinc oxide, stearic acid and zinc stearate;

as regards other additive(s), mention will be made, for example, of:

a conventional reinforcing filler consisting of carbon black; carbon blacks that are suitable for use are all carbon blacks, especially the blacks of the type HAF, ISAF and SAF;

nonlimiting examples of such blacks that may be mentioned include the blacks N115, N134, N234, N339, N347 and N375; the amount of carbon black is determined such that, on the one hand, the white reinforcing filler used represents more than 50% of the weight of the white filler+carbon black mixture, and, on the other hand, the total amount of reinforcing filler (white filler+carbon black) remains within the ranges of values indicated above, for the white reinforcing filler, with respect to the weight composition of the compounds;

a conventional white filler which provides little or no reinforcement, such as, for example, clays, bentonites, talc, chalk, kaolin, titanium dioxide or a mixture of these species;

antioxidants;

antiozonizers such as, for example, N-phenyl-N′-(1,3-dimethylbutyl)-p-phenylenediamine;

plasticizers and processing agents.

As regards the processing agents, the compounds in accordance with the invention may contain reinforcing-filler coating agents, for example comprising the function Y alone, which are capable, in a known manner, by virtue of improving the dispersion of the filler in the rubber matrix and lowering the viscosity of the compounds, of improving the processability of the compounds in raw form. Such processing agents consist, for example, of alkylakoxysilanes (especially alkyltriethoxysilanes), polyols, polyethers (for example polyethylene glycols), primary, secondary or tertiary amines (for example trialkanolamines) and α, ω-dihydroxylated polydimethyl-siloxanes. Such a processing agent, when one is used, is used in a proportion of from 1 to 10 parts by weight and preferably 2 to 8 parts, per 100 parts of white reinforcing filler.

The process for preparing the diene elastomer compounds comprising a white reinforcing filler and at least one coupling agent may be performed according to a standard 1-step or 2-step procedure.

According to the 1-step process, all the required constituents except for the vulcanizing agent(s) and, optionally: the vulcanization accelerator(s) and/or the vulcanization activator(s), are introduced into and blended in a standard internal mixer, for example a Banbury or Brabender mixer. The result of this first mixing step is then taken up in an external mixer, generally a roll mixer, and the vulcanizing agent(s) and, optionally: the vulcanization accelerator(s) and/or the vulcanization activator(s), is (are) then added thereto.

It may be advantageous, for the preparation of certain articles, to perform a process in two steps both carried out in an internal mixer. In the first step, all the required constituents except for the vulcanizing agent(s) and, optionally: the vulcanization accelerator(s) and/or the vulcanization activator(s), are introduced and blended. The aim of the second step that follows is essentially to subject the blend to an additional heat treatment. The result of this second step is also subsequently taken up in an external mixer in order to add thereto the vulcanizing agent(s) and, optionally: the vulcanization accelerator(s) and/or the vulcanization activator(s).

The working phase in the internal mixer is generally performed at a temperature ranging from +80° C. to +200° C. and preferably from +80° C. to +180° C. This first working phase is followed by the second working phase in the external mixer, working at a lower temperature, generally below +120° C. and preferably ranging from +20° C. to +80° C.

The final compound-obtained is then calendered, for example in the form of a sheet, a plaque or a profile that may be used for the manufacture of elastomer articles.

The vulcanization (or curing) is performed in a known manner at a temperature generally ranging from +130° C. to +200° C., optionally under pressure, for a sufficient period that may range, for example, between 5 and 90 minutes depending especially on the curing temperature, vulcanization system selected and the vulcanization kinetics of the compound under consideration.

It goes without saying that the present invention, taken in its fourth subject, relates to the elastomer compounds described above, both in raw form (i.e. before curing) and in cured form (i.e. after crosslinking or vulcanization).

Fifth Subject of the Invention

The elastomer compounds will be used to prepare elastomer articles having a body comprising said compounds described above in the context of the fourth subject of the invention. These compounds are particularly useful for preparing articles consisting of engine mounts, shoe soles, rollers for cable cars, seals for household appliances and cable sheaths.

The examples that follow illustrate the present invention.

I-Examples of Preparation of the Coupling Agents

The melting points (mp), expressed in degrees Celsius (° C.), are determined by projection on a precalibrated Kofler block (ΔT=±2° C.).

The boiling points (b.p.ₚᵣₑₛₛᵤᵣₑ) are given in millibar (mbar).

The 250 MHz proton spectra (¹H NMR) and carbon spectra (¹³C NMR) are recorded on a Bruker AC 250 spectrometer.

The chemical shifts (δc and δh) are expressed in parts per million (ppm) relative to deuteriochloroform (CDCl₃).

The coupling constants noted as J are expressed in Hz.

The following abbreviations are used: s, singulet; bs, broad singulet; d, doublet; t, triplet; q, quartet; m, multiplet.

All the manipulations with the polysilyl organosilicon compounds comprising alkoxysilane residues are performed under inert atmosphere and under anhydrous conditions.

### EXAMPLE 1

N-(3′-trimethoxysilylpropyldithio)-3-trieth-oxysilyl propylamine

A solution of sulfur dichloride (100 mmol; 10.3 g) in 400 ml of anhydrous diethyl ether is cooled to −78° C. in a two-liter 3-neck flask under an argon atmosphere. With mechanical stirring, a mixture of 3-mercaptopropyltrimethoxysilane (100 mmol) and triethylamine (100 mmol; 10.2 g) in 150 ml of anhydrous diethyl ether is added dropwise over one hour. The reaction medium is stirred at this temperature for one hour and a mixture of 3-(triethyoxysilyl) propylaine (110 mmol) and triethylamine (100 mmol; 10.2 g) in 100 ml of anhydrous diethyl ether is then added dropwise over one hour.

The reaction medium is allowed to warm to room temperature, the triethylamine hydrochloride is then filtered off and the filtrate is concentrated under reduced pressure. Distillation under reduced pressure allows the traces of unreacted reagents to be removed.

The compound obtained has the formula:

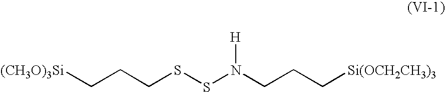

Yield: 75%

Appearance: yellow oil

¹H NMR (CDCl₃) δ_{H} 0.62 (t, 2H, Si—CH₂); 0.74 (t, 2H, Si—CH₂); 1.21 (t, 9H, CH₃—CH₂—O); 1.69 (m, 2H, CH₂); 1.82 (m, 2H, CH₂); 2.88 (t, 2H, SCH₂); 3.07 (t, 2H, NCH₂); 3.55 (s, 9H, O—CH₃); 3.81 (q, 6H, —OCH₂).

¹³C NMR (CDCl₃) δc 6.2 (Si—CH₂); 9.7 (Si—CH₂); 18.4 (CH₃—CH₂); 20.9 (CH₂); 23.8 (CH₂); 44.0 (S—CH₂); 50.6 (—OCH₃); 54.9 (N—CH₂); 58.5 (—OCH₂).

An organoxysilane coupling agent of formula

(VI) was thus prepared, in which:

G³═CH₃O

b′=b=3

R¹═R⁴=propylene

R²═H

R³═—R⁴—Si(G¹)_{3-b}(G²)_{b}

G²═OCH₂CH₃.

### EXAMPLE 2

N-(3′-triethoxysilylpropyldithio)-3-trieth-oxysilyl propylamine

By performing an operating protocol identical to that of example 1, but replacing the 3-mercapto-propyltrimethoxysilane with 3-mercaptopropyltrieth-oxysilane, the compound having the following formula is obtained:

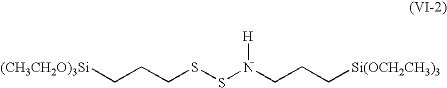

Yield: 86%

Appearance: yellow oil

¹H NMR (CDCl₃) δ_{H} 0.61 (t, 2H, Si—CH₂); 0.72 (t, 2H, Si—CH₂); 1.21 (m, 18H, CH₃—CH₂—O); 1.69 (2, 2H, CH₂); 1.83 (m, 2H, CH₂); 2.89 (t, 2H, S—CH₂); 3.05 (t, 2H, N—CH₂); 3.81 (m, 12H, —OCH₂).

¹³C NMR (CDCl₃) δc 6.2 (Si—CH₂); 9.7 (Si—CH₂); 18.3 (CH₃—CH₂); 18.4 (CH₃—CH₂); 20.9 (CH₂); 23.8 (CH₂); 44.0 (S—CH₂); 54.9 (N—CH₂); 58.5 (—OCH₂); 58.6 (—OCH₂).

### EXAMPLE 3

N,N-bis(3-trimethoxysilylpropyldithio)cyclohexylamine

By performing the operating protocol of example 1, but replacing the 3-(triethoxysilyl)propylamine with cyclohexylamine and using 55 mmol of cyclohexylamine, the compound having the following formula is obtained:

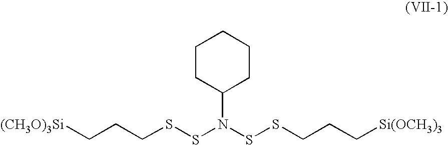

Yield: 85%

Appearance: orange oil

¹H NMR (CDCl₃) δ_{H} 0.73 (m, 4H, Si—CH₂); 1.22 (m, 2H, CH₂);

1.64-1.92 (m, 8H, CH₂); 2.25 (m, 2H, CH₂);

2.40 (m, 2H, CH₂); 2.88 (m, 4H, SCH₂); 3.01 (m, 1H, NCH); 3.56 (S, 18H, —OCH₃).

¹³C NMR (CDCl₃) δ_{c} 8.3 (2×Si—CH₂); 22.3 (2×CH₂); 26.5 (CH₂) 25.9 (2×CH₂); 32.7 (2×CH₂); 41.6 (2×S—CH₂);

50.4 (2×—OCH₃); 59.9 (N—CH)

An organoxysilane coupling agent of formula (VII) was thus prepared, in which:

G³═G²=CH₃O

b′=b=3

R¹═R⁴=propylene

R²=cyclohexyl.

### EXAMPLE 4

N,N-bis(3-triethyoxysilylpropyldithio)cyclohexylamine

By performing the operating protocol of example 3, but replacing the 3-mercaptopropyltrimethoxysilane with 3-mercaptopropyltriethoxysilane, the compound having the following formula is obtained:

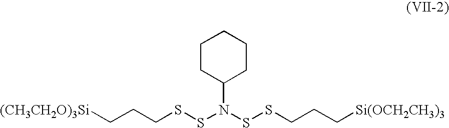

Yield: 90%

Appearance: orange oil

¹H NMR (CDCl₃) δ_{H} 0.75 (t, 4H, Si—CH₂); 1.21 (m, 20H, 6×CH₃ and CH₂); 1.62-1.91 (m, 8H, CH₂); 2.25 (m, 4H, CH₂); 2.40 (m, 2H, CH₂); 2.89 (t, 4H, SCH₂); 3.01 (m, 1H, NCH); 3.81 (q, 12H, —OCH₂).

¹³C NMR (CDCl₃) δ_{c} 9.6 (2×Si—CH₂); 18.1 (2×CH₃); 22.3 (2×CH₂); 26.5 (CH₂); 26.0 (2×CH₂); 32.7 (2 ×CH₂); 41.5 (2×S—CH₂); 58.3 (2×—OCH₂); 59.8 (N—CH)

### EXAMPLE 5

N,N-bis(3-(trimethoxysilylpropyldithio)-3-triethoxysilylpropylamine

By performing the operating protocol of example 3, but replacing the cyclohexylamine with 3-(triethoxysilyl)propylamine, the title compound having the following formula is obtained:

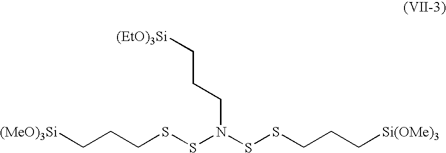

Yield: 87%

Appearance: yellow oil

¹H NMR (CDCl₃) δ_{H} 0.62 (t, 2H, Si—CH₂); 0.74 (t, 4H, Si—CH₂);

1.22 (t, 9H, CH₃—CH₂—O); 1.67 (m, 2H, CH₂); 1.83 (m, 4H, CH₂); 2.82 (t, 4H, S—CH₂); 3.05 (m, 2H, CH₂); 3.55 (s, 18H, O—CH₃); 3.80 (q, 6H, —OCH₂).

¹³C NMR (CDCl₃) δ_{c} 6.2 and 9.7 (3×Si—CH₂); 18.4 (CH₃—CH₂); 20.9 and 23.8 (3×CH₂); 44.0 (2×S—OH₂); 50.6 (2×—OCH₃); 54.9 (N—CH₂); 58.5 (—OCH₂).

### EXAMPLE 6

N-methyl-N-(3′-triethoxysilylpropyldithio)-3′-trimethoxysilylpropylamine

a) Phthalimidosulfenyl chloride

A suspension of 0.1 mol (35.6 g) of phthalimide disulfide in 350 ml of chloroform is heated to 60° C. in a three-necked flask equipped with magnetic stirring. A stream of chlorine gas is passed through until dissolution is complete. The reaction medium is cooled to room temperature and the solvent is then evaporated off under reduced pressure. The phthalimidosulfenyl chloride is recrystallized from dichloromethane.

Yield: 99%

Appearance: yellow crystals

Melting point: 140° C.

¹H NMR (CDCl₃) δ_{H}: 7.90 (m, 2H aromatic); 8.01 (m, 2H aromatic).

¹³C NMR (CDCl₃) δ_{c} 124.7 (2 CH aromatic); 131.6 (2 C aromatic);

135.6 (2 CH aromatic); 165.8 (2 C═O).

b) N-(N′-methyl-N′-3′-trimethoxysilylpropyl)-aminothiophthalimide

Phthalimidosulfenyl chloride (0.1 mol; 21.35 g) is dissolved in 350 ml of chloroform in a three-necked flask equipped with magnetic stirring and under an inert atmosphere. 0.21 mol of N-methyl-N-(3-trimethoxysilylpropyl)amine diluted in 50 ml of chloroform is added dropwise at room temperature. The mixture is stirred for 3 hours and the solvent is then evaporated off. The residue is taken up in diethyl ether, the amine hydrochloride is filtered off and the filtrate is then concentrated under reduced pressure.

Yield: 88%

Appearance: orange-oil

¹H NMR (CDCl₃) δ_{H} 0.64 (t, 2H, Si—CH₂); 1.78 (m, 2H, CH₂); 2.93 (H₃C—N); 3.05 (t, 2H N—CH₂); 3.56 (s, 9H —OCH₃); 7.77 (m, 2H aromatics); 7.92 (m, 2H aromatics).

¹³C NMR (CDCl₃) δ_{c} 5.9 (SiCH₂); 21.0 (CH₂); 46.8 (N—CH₃); 50.5 (—OCH₃); 62.9 (N—CH₂); 123.8 (2 CH aromatics); 132.3 (2 C aromatics); 134.2 (2 CH aromatics); 169.5 (C═O).

c) N-methyl-N-(3′-triethoxysilylpropyldithio)-3′-trimethoxysilylpropylamine

The sulfide obtained in the proceeding step (50 mmol) is dissolved in 250 ml of benzene in a three-necked lask equipped with magnetic stirring and under an inert atmosphere. 3-mercaptopropyltriethoxysilane (45 mmol) diluted in a minimum amount of benzene is added in a single portion. The mixture is stirred at room temperature for 48 hours. The precipitated phthalimide and the excess sulfide are filtered off and the solvent is then evaporated off under reduced pressure.

The compound obtained has the formula:

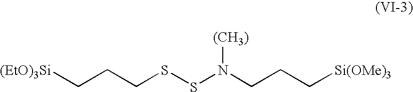

Yield: 95%

Appearance: yellow oil

¹H NMR (CDCl₃) δ_{H} 0.61 (t, 2H, Si—CH₂); 0.72 (t, 2H, Si—CH₂);

1.22 (t, 9H, CH₃), 1.68 (m, 2H, CH₂); 1.80 (m, 2H, CH₂); 2.68 (NCH₃); 2.75 (t, 2H, CH₂); 2.88 (t, 2H, CH₂); 3.57 (s, 9H, —OCH₃) 3.82 (q, 6H, O—CH₂).

¹³C NMR (CDCl₃) δ_{c} 6.2 (Si—CH₂); 9.7 (Si—CH₂); 18.4 (CH₃—CH₂); 20.9 (CH₂); 23.8 (CH₂); 44.0 (S—CH₂); 46.1 (—NCH₃); 50.6 (—OCH₃); 58.5 (—OCH₂); 60.9 (N—CH₂).

II-Examples of Preparation of Rubber Compounds

### EXAMPLES 7 and 8

The aim of these examples is to demonstrate the improved coupling performance quality (white filler-diene elastomer) of a bis-alkoxysilanedithiosulfenamide of formula (VII-2); these performance qualities are compared with those of a conventional coupling agent, TESPT. To do this, various diene elastomer compounds are prepared, reinforced with a white filler based on precipitation silica, said compounds being representative of shoe sole formulations.

It is recalled that TESPT is bis(3-triethoxysilylpropyl) tetrasulfide of formula [(C₂H₅O)₃Si(CH₂)₃S₂]₂; it is sold, for example, by the company Degussa under the name Si69 or by the company Witco under the name Silquest A1289 (in both cases, as a commercial blend of polysulfides S_{y} with a mean value for y of close to 4).

The structural formula of TESPT is:

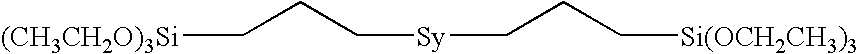

This formula may be compared with that of the bis-alkoxysilanedithiosulfenamide coupling agent of formula (VII-2):

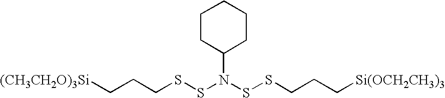

It is noted that a portion of the above two chemical structures is identical (function Y and hydrocarbon-based group—in this case propylene chain—for linking Y and X), the only difference lying in the nature of the sulfur-containing function (function X) graftable onto the diene elastomer: polysulfide group S_{y} for the conventional compound, dithiosulfenamide group for the compound of the invention.

The two coupling agents are used herein in an isomolar amount of silicon, i.e. irrespective of the compound, the same number of moles of functions Y (in this case Y═Si(OEt)₃) that are reactive toward silica, and of its surface hydroxyl groups.

Relative to the weight of reinforcing filler, the content of coupling agent in all cases represents less than 10% by weight relative to the amount of reinforcing filler.

1) Constitution of the Compounds:

The following compounds, the constitution of which, expressed in parts by weight, is given in table I below, are prepared in a Brabender internal mixer:

TABLE I

| | Control | Control | | Control | Control | |
|---|---|---|---|---|---|---|
| Compound | 1 | 2 | Ex. 7 | 3 | 4 | Ex. 8 |
| NR rubber (1) | 100 | 100 | 100 | — | — | — |
| SBR rubber (2) | — | — | — | 100 | 100 | 100 |
| Silica (3) | 50 | 50 | 50 | 40 | 40 | 40 |
| Zinc oxide (4) | 3.5 | 3.5 | 3.5 | 3 | 3 | 3 |
| Stearic | 3.5 | 3.5 | 3.5 | 1.5 | 1.5 | 1.5 |
| acid (5) | | | | | | |
| PEG (6) | — | — | — | 3 | — | — |
| TESPT | — | 4 | — | — | 3.2 | — |
| compound | | | | | | |
| Compound | — | — | 4.7 | — | — | 3.8 |
| (VII-2) | | | | | | |
| CBS (7) | 3 | 3 | 3 | — | — | — |
| MBTS (8) | — | — | — | 1.5 | 1.5 | 1.5 |
| DPG (9) | — | — | — | 1.2 | 1.2 | 1.2 |
| Sulfur (10) | 1.7 | 1.7 | 1.7 | 2.2 | 2.2 | 2.2 |

(1) Natural rubber, of Malaysian origin, sold by the company Safic-Alcan under the reference SMR 5L.
(2) Styrene-butadiene copolymer, sold by the company Shell Chimie under the reference SBR 1502.
(3) Highly dispersible silica Zeosil 1165 MP, sold by the company Rhodia Silices.
(4) and (5) vulcanization activators.
(6) Polyethylene glycol of molecular weight 4 000.
(7) N-Cyclohexyl-2-benzothiazylsulfenamide (vulcanization accelerator)
(8) Mercaptobenzothiazole disulfide (vulcanization accelerator).
(9) Diphenylguanidine (vulcanization accelerator).
(10) Vulcanizing agent.

2) Constitution of the Compounds:

Compounds of the controls land 2 and of example 7:

The various constitutes are introduced in order, at the times and temperatures indicated below, into a Brabender internal mixer:

| Time | Temperature | Constituents |
|---|---|---|
| 0 minute | 90° C. | NR rubber |
| 2 minutes | 120° C. | ⅔ silica + coupling agent |
| 4 minutes | 135° C. | ⅓ silica + stearic acid + |
| | | zinc oxide |
| 5 minutes | 150° C. | Emptying |

The emptying or discharging of the contents of the mixer is performed after 5 minutes. The temperature reached is 150° C.

The blend obtained is then introduced into a roll mixer, maintained at 30° C., and the CBS and the sulfur are introduced. After homogenization, the final blend is calendered in the form of sheets from 2.5 to 3 mm thick.

Compounds of controls 3 and 4 and of example 8:

The various constituents are introduced in order, at the times and temperatures indicated below, into a Brabender internal mixer:

| Time | Temperature | Constituents |
|---|---|---|
| 0 minute | 90° C. | SBR rubber |
| 2 minutes | 115° C. | ⅔ silica + coupling agent |
| 4 minutes | 130° C. | ⅓ silica + stearic acid + |
| | | zinc oxide |
| 5 minutes | 145° C. | Emptying |

The emptying or discharge of the contents of the mixer is performed after 5 minutes. The temperature reached is 145° C.

The blend obtained is then introduced into a roll mixer, maintained at 30° C., and the MBTS, the DPG and the sulfur are introduced. After homogenization, the final blend is calendered in the form of sheets from 2.5 to 3 mm thick.

3) Rheological Properties of the Compounds:

The measurements are performed on the compounds in raw form. Table II below gives the results concerning the rheology test, which is performed at 150° C. over 30 minutes using a Monsanto 100 S rheometer.

According to this test, the test compound is placed in the test chamber adjusted to a temperature of 150° C., and the torque, opposed by the compound, that resists a low-amplitude oscillation of a biconical spindle included in the test chamber is measured, the compound completely filling the chamber under consideration. From the curve of the variation of the torque as a function of time, the following are determined: the minimum torque, which reflects the viscosity of the compound at the temperature under consideration; the maximum torque and the delta-torque, which reflect the degree of crosslinking entrained by the action of the vulcanization system; the time T-90 required to obtain a degree of vulcanization corresponding to 90% of total vulcanization (this time is taken as the vulcanization optimum); and the scorch time TS-2 corresponding to the time required to obtain a rise 2 points above the minimum torque at the temperature under consideration (150° C.), which reflects the time for which it is possible to use the raw blends at this temperature without vulcanization being initiated.

The results obtained are given in table II.

TABLE II

| Monsantorheology | Control 1 | Control 2 | Example 7 | Control 3 | Control 4 | Example 8 |
|---|---|---|---|---|---|---|
| Minimum torque | 17.9 | 11.6 | 10 | 18.9 | 14 | 12 |
| Maximum torque | 82.5 | 95.5 | 98.7 | 97 | 100 | 102 |
| Delta-torque | 64.6 | 83.9 | 88.7 | 76.1 | 86 | 90 |
| TS-2 (minutes, | 12′30″ | 9′56″ | 9′46″ | 3′30″ | 4′ | 3′50″ |
| seconds) | | | | | | |
| T-90 (minutes, | 21′20″ | 19′05″ | 14′05″ | 7′30″ | 12′20″ | 9′30″ |
| seconds) | | | | | | |

4) Mechanical Properties of the Vulcanizates:

The measurements are performed on the compounds uniformly vulcanized for 40 minutes at 150° C.

The properties measured and the results obtained are collated in table III below:

TABLE III

| Mechanical properties | Control 1 | Control 2 | Ex. 7 | Control 3 | Control 4 | Ex. 8 |
|---|---|---|---|---|---|---|
| 100% modulus (1) | 1.2 | 3.3 | 3.9 | 1.8 | 2.2 | 2.4 |
| 300% modulus (1) | 3.9 | 14.3 | 17.5 | 4.7 | 10.3 | 11.7 |
| Elongation at break (1) | 740 | 470 | 410 | 630 | 460 | 450 |
| Breaking strength (1) | 23.7 | 25.5 | 25 | 16.2 | 18.6 | 19.5 |
| Reinforcement indices: | 3.25 | 4.33 | 4.5 | 2.6 | 4.7 | 4.9 |
| 300% M/100% M | | | | | | |
| Shore A hardness (2) | 58 | 72 | 72 | 70 | 68 | 68 |
| Abrasion resistance (3) | 270 | 98 | 92 | 190 | 121 | 106 |
| Dynamic properties at | 0.123 | 0.069 | 0.053 | — | — | — |
| 70° C.: tangent delta (4) | | | | | | |

(1) The tensile tests are performed in accordance with the indications of standard NF T 46-002 with specimens of H2 type. The 100% modulus, 300% modulus and breaking strength are expressed in MPa; the elongation at break is expressed in %.
(2) The measurement is performed according to the indications of ASTM standard D 3240. The value given is measured at 15 seconds.
(3) The measurement is performed according to the indications of standard NF T 46-012 using method 2 with a rotating specimen holder. The value measured is the loss of substance (in mm³) on abrasion; the smaller the value, the better the abrasion resistance.
(4) The tangent delta expresses the ratio between the viscous modulus and the elastic modulus of the vulcanizate under the test conditions (sinusoidal bending at 70° C., bending frequency of 10 Hertz and bending amplitude of plus or minus 4%). The lower this value, the less energy will be absorbed by the vulcanized specimen under the specified test conditions, and the larger the amount of energy restituted.

Examination of the various results leads to the following observations:

it is found that TESPT makes it possible both to lower the viscosity of the raw blend (cf. minimum torque) and to increase the maximum torque and the delta-torque, but the coupling agent according to the present invention is, in this respect, more efficient than TESPT, since it produces raw blends that have a lower viscosity and a higher maximum torque, resulting in a higher delta-torque;

it is also found that the vulcanization kinetics (cf. the T-90 time, which is a reflection of the vulcanization kinetics) are accelerated with the coupling agent according to the present invention, compared with that which takes place with TESPT, which constitutes a real advantage since the scorch time TS-2 is not significantly changed;

it is also found, as regards the modulus values and the reinforcing index, that, compared with the control containing TESPT (controls 2 and 4), the coupling agent according to the present invention affords higher modulus values, but this increase is more substantial for the large elongations, which is demonstrated by an increase in the reinforcement index; such an increase in the reinforcement index reflects better coupling of the white filler to the rubber matrix;

it is also found, as regards the abrasion resistance, that the coupling agent according to the invention affords good abrasion resistance, which is equal to or greater than that obtained with TESPT;

finally, it is found that the lowest tangent delta value (which reflects the energy absorbed or restituted by the vulcanizate during bending under the test conditions mentioned) is obtained with the coupling agent according to the invention. In this case, this result thus indicates that the energy absorbed is lower in the case of the vulcanizate comprising the coupling agent according to the invention.

1. An organosilicon compound comprising, per molecule, linked to silicon atoms, on the one hand, at least one hydroxyl group or a hydrolyzable monovalent group, and, on the other hand, a function X capable of reacting with a rubber elastomer, wherein said organosilicon compound comprising the function X comprises at least one polythiosulfenamide functional group of formula:
—R¹—SX—NR²R³ (I)
in which:
the free valency is linked to a silicon atom of the organosilicon compound;
the symbol R¹ represents a divalent radical chosen from: a saturated or unsaturated aliphatic hydrocarbon-based group; a saturated, unsaturated and/or aromatic, monocyclic or polycyclic carbocyclic group; and a group containing a saturated or unsaturated aliphatic hydrocarbon-based portion and a carbocyclic portion as defined above; said divalent radical being optionally substituted or interrupted with an oxygen atom and/or a nitrogen atom bearing 1 or 2 monovalent groups selected from: a hydrogen atom; a saturated or unsaturated aliphatic hydrocarbon-based group; a saturated, unsaturated and/or aromatic, monocyclic or polycyclic carbocyclic group; and a group containing a saturated or unsaturated aliphatic hydrocarbon-based portion and a carbocyclic portion as defined above;
x is an integer or fractional number ranging from 2 to 4;
one of the substituents of the nitrogen atom, R² or R³, represents: a hydrogen atom; a saturated aliphatic hydrocarbon-based group; a saturated and/or aromatic, monocyclic or polycyclic carbocyclic group; a group containing a saturated aliphatic hydrocarbon-based portion and a saturated and/or aromatic, monocyclic or polycylic carbocyclic portion; or the group of formula:
—Sₐ—R⁴—Si≡ (II)
in which:
a represents a number equal to 0 or x; when a=x, the symbols x of formulae (I) and (II) may then be identical or different;
the symbol R⁴ takes any of the meanings given above for R¹, the symbols R¹ and R⁴ optionally being identical or different;
the symbol Si≡ represents a silicon atom of the organosilicon compound other than the atom to which the free valency of the radical R¹ of formula (I) is linked;
the other substituent of the nitrogen atom, R³ or R², respectively, represents the group of formula (II) as defined above, with the condition according to which the symbol Si≡ then represents a silicon atom of the organosilicon compound, which, on the one hand, is other than the silicon atom to which the free valency of the radical R¹ of formula (I) is linked, and, on the other hand, is again other than the silicon atom of the other group of formula (II), in the case where the two substituents of the nitrogen atom, R² and R³, each represent a group of formula (II).

2. The organosilicon compound as claimed in claim 1, wherein the polythiosulfenamide group corresponds to formula (I) in which at least one of the substituents of the nitrogen atom, R² and R³, has the formula (II) with a=0, i.e. when it is R³ that has said formula (II) with a=0, it corresponds to the formula: 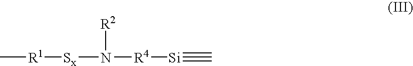
in which:
R¹ represents: a C₁-C₈ alkylene chain; a saturated C₅-C₁₀ cycloalkylene group; a C₆-C₁₈ arylene group; or a divalent group consisting of a combination of at least two of these radicals;
x is an integer or fractional number ranging from 2 to 3;
R² represents: a hydrogen atom; a linear or branched C₁-C₈ alkyl radical; a C₅-C₁₀ cycloalkyl radical; a C₆-C₁₈ aryl radical; a (C₆-C₁₈) aryl (C₁-C₈) alkyl radical; or the group of formula (II) in which a=0 and R⁴ has the definitions mentioned below in the present claim;
the symbol R⁴ takes any of the meanings given above for R¹ in the present claim, the symbols R¹ and R⁴ possibly being identical or different.

3. The organosilicon compound as claimed in claim 2, wherein the polythiosulfenamide group corresponds to formula (I) in which only one of the substituents of the nitrogen atom, R² or R³, has the formula (II) with a=x, corresponding, when it is R³ that has said formula (II) with a=x, to the formula: 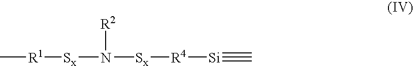
in which the symbols R¹, x, R² and R⁴ take any of the meanings given above with the additional condition according to which the symbols x of the formula given above may be identical or different.

4. The organosilicon compound as claimed in claim 1, which is selected from functional polysilyl organosilicon compounds bearing a polythiosulfenamide group, corresponding to the general formula:
(G²)_{b}(G¹)_{3-b}Si—R¹—Sₓ—NR²R³ (V)
in which:
b represents a number selected from 1, 2 and 3;
the symbols G¹, which may be identical or different, each represent: a saturated or unsaturated aliphatic hydrocarbon-based group; a saturated, unsaturated and/or aromatic, monocyclic or polycyclic carbocyclic group; or a group containing a saturated or unsaturated aliphatic hydrocarbon-based portion and a carbocyclic portion as defined above;
the symbols G², which may be identical or different, each represent: a hydroxyl group or a hydrolyzable monovalent group;
R¹, x, R² and R³ take any of the general meanings given above with respect to the formula (I), with the additional condition according to which one of the substituents R² or R³ or both the substituents R² and R³ then represent(s) a silyl group of formula:
—Sₐ—R⁴—Si(G⁴)_{3-b′}(G³)_{b′} (II′)
in which:
a and R⁴ have the general meanings given above with respect to formula (II);
G³, G⁴ and b′ have, respectively, the same meanings as G², G¹ and b given just above in formula (V), the symbols G³, G⁴ and b′ optionally being, respectively, identical to or different than the symbols G², G¹ and b.

5. The organosilicon compound as claimed in claim 2, which is selected from functional polysilyl organisilicon compounds in which, in the polythiosulfenamide group, at least one of the substituents R² and R³ corresponds to the particular formula (II′) with a=0; such compounds, in the case where only one substituent R³ corresponds to the particular formula (II′) with a=0, having the formula: 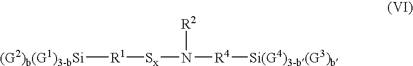
in which:
R¹, x, R² and R⁴ take any of the meanings given above;
b represents a number selected from 1, 2 and 3;
the symbols G¹, which may be identical or different, each represent: a linear or branched C₁-C₈ alkyl radical; a C₅-C₁₀ cycloalkyl radical or a C₆-C₁₈ aryl radical;
the symbols G², which may be identical or different, each represent: a linear or branched C₁-C₈ alkoxy radical, optionally substituted with one or more (C₁-C₈) alkoxy groups;
G³, G⁴ and b′ have, respectively, the same broad or specific definitions as G², G¹ and b given just above, the symbols G³, G⁴ and b′ possibly being, respectively, identical to or different than the symbols G², G¹ and b.

6. The organosilicon compound as claimed in claim 2, which is selected from functional polysilyl organosilicon compounds in which, in the polythiosulfenamide group, only one of the substituents R² or R³ corresponds to the particular formula (II′) with a=x; such compounds, in the case where it is the substituent R³ that alone corresponds to the particular formula (II′) with a=x having the formula: 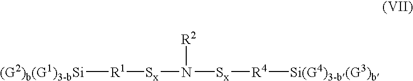
in which R¹, x, R², R⁴, b, G¹, G², G³, G⁴ and b′ have, respectively, the same meanings as those given above, the symbols x possibly being identical or different and the symbols R⁴, G³, G⁴ and b′ possibly being, respectively, identical to or different than the symbols R¹, G², G¹ and b.

7. A process for preparing the organosilicon compounds as claimed in claim 4, wherein, when x=2, said compounds are obtained by reacting a disulfide halide of formula:
(G²)_{b}(G¹)_{3-b}Si—R¹—S—S-Hal (VIII)
in which G², G¹, b and R¹ are as defined above and Hal represents a halogen atom, with the appropriate amine of formula:
HNR²R³ (IX)
in which R² and R³ are as defined above, in the presence of a base.

8. The process for preparing the organosilicon compounds as claimed in claim 4, wherein, when x=2, said compounds are obtained by reacting a disulfide of formula:
(G²)_{b}(G¹)_{3-b}Si—R¹—S—S—J (X)
in which G², G¹, b and R¹ are as defined above and J represents an optionally substituted succinimido or phthalimido group, with the amine HNR²R³ (IX) defined above, in the presence of a base.

9. The process for preparing the organosilicon compounds as claimed in claim 4, wherein, when x=2, said compounds are obtained by reacting an amino sulfide of formula:
J—S—NR²R³ (XI)
in which R², R³ and J are as defined above, with a thiol of formula:
(G²)_{b}(G¹)_{3-b}Si—R¹—SH (XII)
in which G², G¹, b and R¹ are as defined above, in the presence of a base.

10. The process for preparing the organosilicon compounds as claimed in 4, wherein, when x=3, said compounds are obtained by performing the following sequence of steps:
(1) reaction of the thiol of formula (XII) with S₂(Hal)₂ in which Hal represents a halogen atom, in the presence of a base, to give:
(G²)_{b}(G¹)_{3-b}Si—R¹—S—S—S-Hal (XVII)
this reaction being performed in an ether at a temperature of from −78 to −50° C.;
(2) reaction of compound (XVII) with the appropriate amine of formula (IX) in the presence of a base.

11. The process for preparing the organosilicon compounds as claimed claim 4, wherein, when x=4, said compounds are obtained by performing the following sequence of steps:
(1) reaction of a disulfide halide of formula (VIII) or of the trisulfide halide of formula (XVII) with the required amount of elementary sulfur [provision of 2 sulfur atoms in the case of compound (VIII) or provision of one sulfur atom in the case of compound (XVII)], working at a temperature ranging from +70° C. to +170° C., optionally in the presence of an aromatic solvent, to give the compound of formula:
(G²)_{b}(G¹)_{3-b}Si—R¹—S—S—S—S-Hal (XVIII)
(2) reaction of the compound of formula (XVIII) with the appropriate amine of formula (IX) in the presence of a base.

12. The white filler-elastomer coupling agent comprising an effective amount:
(i) of at least one organosilicon compound bearing group(s) containing a polythiosulfenamide function of formula (I), (III) or (IV) as claimed in claim 1,
in compounds comprising at least one diene elastomer and a white filler as reinforcing filler, these compounds being intended for manufacturing articles made from diene elastomer(s).

13. A diene elastomer compound comprising a reinforcing white filler, obtained by using an effective amount (i) of at least one organosilicon compound bearing group(s) containing a polythiosulfenamide function of formula (I), (III) or (IV) as claimed in claim 1.

14. The compound as claimed in claim 13, which comprises (the parts are given on a weight basis):
per 100 parts of diene elastomer(s),
10 to 200 parts of reinforcing white filler, and
1 to 20 parts of coupling agent(s).

15. The compound as claimed in claim 14, which comprises:
per 100 parts of diene elastomer(s),
20 to 150 parts of reinforcing white filler, and
2 to 20 parts of coupling agent(s).

16. The compound as claimed in claim 13, wherein the reinforcing white filler comprises silica, alumina or a mixture of these two species.

17. The compound as claimed in claim 16, wherein:
the silica is a standard or highly dispersible precipitation silica with a BET specific surface area ≦450 m²/g;
the alumina is a highly dispersible alumina with a BET specific surface area ranging from 30 to 400 m²/g and a high content of Al—OH reactive surface functions.

18. The compound as claimed in claim 13, wherein the diene elastomer(s) is (are) selected from:
(1) homopolymers obtained by polymerization of a conjugated diene monomer containing from 4 to 22 carbon atoms;
(2) copolymers obtained by copolymerization of at least two of the abovementioned conjugated dienes with each other or by copolymerization of one or more of the abovementioned conjugated dienes with one or more ethylenically unsaturated monomers chosen from:
vinylaromatic monomers containing from 8 to 20 carbon atoms;
vinyl nitrile monomers containing from 3 to 12 carbon atoms;
acrylic ester monomers derived from acrylic acid or from methacrylic acid with alkanols containing from 1 to 12 carbon atoms;
the copolymers may contain between 99% and 20% by weight of diene units and between 1% and 80% by weight of vinylaromatic, vinyl nitrile and/or acrylic ester units;
(3) ternary copolymers obtained by copolymerization of ethylene or of an α-olefin containing 3 to 6 carbon atoms with a nonconjugated diene monomer containing from 6 to 12 carbon atoms;
(4) natural rubber;
(5) copolymers obtained by copolymerization of isobutene and isoprene (butyl rubber), and also the halogenated versions of these copolymers;
(6) a blend of several of the abovementioned elastomers (1) to (5) with each other.

19. The compound as claimed in claim 18, comprising one or more elastomer(s) selected from: (1) polybutadiene, polychloroprene or polyisoprene [or poly(2-methyl-1,3-butadiene)]; (2) poly(isoprene-butadiene), poly(isoprene-styrene), poly(isoprene-butadiene-styrene), poly(butadiene-styrene) or poly(butadiene-acrylonitrile); (4) natural rubber; (5) butyl rubber; (6) a blend of elastomers, especially the abovementioned elastomers (1), (2), (4) and (5) with each other; (6′) a blend containing a majority amount (ranging from 51% to 99.5% by weight) of polyisoprene (1) and/or of natural rubber (4) and a minority amount (ranging from 49% to 0.5% by weight) of polybutadiene, polychloroprene, poly(butadiene-styrene) and/or poly(butadiene-acrylonitrile).

20. The compound as claimed in claim 13, which further comprises all or some of the other auxiliary constituents and additives usually used in elastomer and rubber compounds, said other constituents and additives comprising:
when it is a vulcanization system:
vulcanizing agents selected from sulfur and sulfur-donating compounds;
vulcanization accelerators;
vulcanization activators;
when it is another additive (or additives):
a conventional reinforcing filler consisting of carbon black;
a conventional white filler with little or no reinforcing nature;
antioxidants;
antiozonizers;
plasticizers and processing agents.

21. A process for preparing the diene elastomer compounds as claimed in claim 13, wherein:
all the required constituents with the exception of the vulcanizing agent(s) and optionally: of the vulcanization accelerator(s) and/or of the vulcanization activator(s), are introduced into and blended in a standard internal mixer, in one or two steps, working at a temperature ranging from +80° C. to +200° C.;
the blend thus obtained is then taken up in an external mixer and the vulcanizing agent(s) and optionally: the vulcanization accelerator(s) and/or the vulcanization activator(s) is (are) then added thereto, working at a lower temperature, below +120° C.

22. An elastomer article, comprising a body comprising a compound as claimed in claim 13.

23. The article as claimed in claim 22, comprising engine blocks, shoe soles, rollers for cable cars, seals for household electrical appliances and cable sheaths.
